(19) United States
(12) Patent Application Publication
(10) Pub. No.: US 2026/0190071 A1
(43) Pub. Date: Jul. 2, 2026

(54) MONITORING FOR CONTROL INFORMATION IN A POSITIONING MEASUREMENT GAP

(71) Applicant: Nokia Technologies Oy, Espoo (FI)

(72) Inventors: Mads LAURIDSEN, Aalborg (DK); Jing Yuan SUN, Beijing (CN); Ping YUAN, Beijing (CN)

(21) Appl. No.: 19/227,244

(22) Filed: Jun. 3, 2025

Related U.S. Application Data
(63) Continuation of application No. 18/836,123, filed on Aug. 6, 2024.

(30) Foreign Application Priority Data
Aug. 9, 2023 (WO) PCT/CN2023/112073

(51) Int. Cl. H04W 64/00; G01S 19/33; H04W 72/23; H04W 76/28; H04W 84/06

(52) U.S. Cl. CPC H04W 64/00; G01S 19/33; H04W 72/23; H04W 76/28; H04W 84/06

(57) ABSTRACT

Example embodiments of the present disclosure relate to a solution for monitoring for control information in a position measurement gap. In this solution, a first apparatus determines a first time point for a transmission of first information indicating the completion of the positioning measurement; and then determines whether to start monitoring for control information from a second apparatus before an end of the positioning measurement gap based on at least one of the following: the first time point, a round-trip time (RTT) between the first apparatus and the second apparatus, a processing time required by the second apparatus for processing the first information, or an offset associated with monitoring the control information.

### FIELD

Various example embodiments of the present disclosure generally relate to the field of telecommunication and in particular, to methods, devices, apparatuses and computer readable storage medium of monitoring for control information in a position measurement gap.

### BACKGROUND

In new radio (NR) non terrestrial network (NTN), it is assumed that user equipment (UE) always has a capability of global navigation satellite system (GNSS) measurement and will achieve its location according to the measured GNSS information. In the following, more works about supporting internet of things (IoT) over non-terrestrial network (NTN) will be discussed. The 3rd generation partnership project (3GPP) assumes that the UE cannot operate GNSS and IoT NTN simultaneously and therefore radio access network work group 1 (RAN1) and RAN WG2 (RAN2) specify the GNSS measurement gaps, where the UE can perform the GNSS measurement without monitoring the physical downlink control channel (PDCCH) and performing other “3GPP tasks”.

### SUMMARY

In a first aspect of the present disclosure, there is provided a first apparatus. The first apparatus comprises at least one processor; and at least one memory storing instructions that, when executed by the at least one processor, cause the first apparatus to: in accordance with a determination that a positioning measurement is completed in a positioning measurement gap, determine a first time point for a transmission of first information indicating the completion of the positioning measurement; and determine whether to start monitoring for control information from a second apparatus before an end of the positioning measurement gap based on at least one of the following: the first time point, a round-trip time (RTT) between the first apparatus and the second apparatus, a processing time required by the second apparatus for processing the first information, or an offset associated with monitoring the control information.

In a second aspect of the present disclosure, there is provided a second apparatus. The second apparatus comprises at least one processor; and at least one memory storing instructions that, when executed by the at least one processor, cause the second apparatus to: receive, from a first apparatus, first information indicating a completion of a positioning measurement during a positioning measurement gap; and determine whether to transmit control information to the first apparatus before an end of the positioning measurement gap based on at least one of the following: a first time point for a transmission of the first information, a third time point for a receipt of the first information, a round-trip time (RTT) between the first apparatus and the second apparatus, a processing time required by the second apparatus for processing the first information, or an offset associated with monitoring the control information.

In a third aspect of the present disclosure, there is provided a method. The method comprises: in accordance with a determination that a positioning measurement is completed in a positioning measurement gap, determining a first time point for a transmission of first information indicating the completion of the positioning measurement; and determining whether to start monitoring for control information from a second apparatus before an end of the positioning measurement gap based on at least one of the following: the first time point, a round-trip time (RTT) between the first apparatus and the second apparatus, a processing time required by the second apparatus for processing the first information, or an offset associated with monitoring the control information.

In a fourth aspect of the present disclosure, there is provided a method. The method comprises: receiving, from a first apparatus, first information indicating a completion of a positioning measurement during a positioning measurement gap; and determining whether to transmit control information to the first apparatus before an end of the positioning measurement gap based on at least one of the following: a first time point for a transmission of the first information, a third time point for a receipt of the first information, a round-trip time (RTT) between the first apparatus and the second apparatus, a processing time required by the second apparatus for processing the first information, or an offset associated with monitoring the control information.

In a fifth aspect of the present disclosure, there is provided a first apparatus. The first apparatus comprises means for in accordance with a determination that a positioning measurement is completed in a positioning measurement gap, determining a first time point for a transmission of first information indicating the completion of the positioning measurement; and means for determining whether to start monitoring for control information from a second apparatus before an end of the positioning measurement gap based on at least one of the following: the first time point, a round-trip time (RTT) between the first apparatus and the second apparatus, a processing time required by the second apparatus for processing the first information, or an offset associated with monitoring the control information.

In a sixth aspect of the present disclosure, there is provided a second apparatus. The second apparatus comprises means for receiving, from a first apparatus, first information indicating a completion of a positioning measurement during a positioning measurement gap; and means for determining whether to transmit control information to the first apparatus before an end of the positioning measurement gap based on at least one of the following: a first time point for a transmission of the first information, a third time point for a receipt of the first information, a round-trip time (RTT) between the first apparatus and the second apparatus, a processing time required by the second apparatus for processing the first information, or an offset associated with monitoring the control information.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for communication according to some example embodiments of the present disclosure;

FIGS. 3A and 3B illustrate timings for monitoring for control information in a positioning measurement gap;

FIGS. 4A and 4B illustrate timings for monitoring for control information in a positioning measurement gap;

FIG. 5 illustrates a flowchart of a method implemented at a first apparatus according to some example embodiments of the present disclosure;

FIG. 6 illustrates a flowchart of a method implemented at a first apparatus according to some example embodiments of the present disclosure;

FIG. 7 illustrates a flowchart of a method implemented at a second apparatus according to some example embodiments of the present disclosure;

FIG. 8 illustrates a simplified block diagram of a device that is suitable for implementing example embodiments of the present disclosure; and

FIG. 9 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT), enhanced machine type communication (eMTC) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As discussed above, in NR NTN, IoT NTN or other types of NTN, it is assumed that the UE always has capability of GNSS measurement and will achieve its location according to the measured GNSS information.

The GNSS may be used by the UE to determine its location such that the UE can compensate for the radio propagation between the UE and the satellite. This enables the UE to pre-compensate uplink transmissions in time & frequency domain such that the long propagation distance towards the satellite is accounted for (up to 36000 km for a geo-stationary satellite). The UE may also account for satellite movement in case of low-earth orbit satellites, since such satellites move with 7.5 km/s relative to Earth.

In the present discourse, the GNSS measurement may be either triggered by the network device or the UE.

Specifically, the network device may trigger the UE to perform a GNSS measurement during a scheduled gap. Additionally, in some example embodiments, the network device may at least support to trigger the UE to perform GNSS measurement aperiodically. In case of the aperiodically trigger, the network device may use a (medium access control) MAC control element (CE) or a radio resource control (RRC) signaling to trigger the UE to perform the GNSS measurement. The triggering by the network device is expected to be based on the reported GNSS validity duration. In case that the UE is in connected mode, the UE may report GNSS validation duration with MAC CE. Additionally, in some example embodiments, the UE is also required to report the “GNSS position fix time duration” (i.e., the time required by the UE to perform the GNSS measurements) at least during the initial access stage. The parameter “GNSS position fix time duration” may be used by the network device to determine the GNSS measurement gap length. In some example embodiments, a new downlink MAC CE may be introduced to trigger connected UE to perform GNSS measurement.

For GNSS measurement in the radio resource control (RRC) connected, if the network device aperiodically triggers connected UE to make GNSS measurement, the UE may re-acquire GNSS position fix with a gap.

For the GNSS measurement gap aperiodically triggered with MAC CE, the duration for the GNSS measurement gap may be configured by eNB. Additionally, the gap duration is equal to the latest reported GNSS position fix time duration for measurement when the duration for GNSS measurement gap is not included in the configuration by eNB.

If the UE does not receive a trigger for GNSS measurement from the network device, the UE may autonomously perform the GNSS measurement. In this scenario, the network device and the UE should have a common understanding about when and how to start the GNSS measurement. As one specific embodiment, as the UE is not available for scheduling during the GNSS measurement period, the UE may autonomously perform the GNSS measurement at the expiry of the GNSS validity duration.

As one specific embodiment, as for the GNSS measurement in RRC connected, if the network device aperiodically triggers the UE which is in a connected state to perform the GNSS measurement. Further, when configured to enable autonomously triggering GNSS measurement, the UE may reacquire GNSS autonomously if the UE does not receive a trigger to perform the GNSS measurement from the network device.

From RAN1 perspective, at least for the case when frequency error and timing error are within frequency and timing error requirements with legacy closed loop time correction, the uplink transmission may be allowed in a duration X after original GNSS validity duration expires without GNSS re-acquisition.

The UE may be not required to transmit or receive any channel/signal within the aperiodic GNSS measurement gap duration before the UE reacquires GNSS successfully.

Further, the UE may report one GNSS position fix time duration for GNSS measurement via a 4-bit field with component values [1, 2, 3, 4, 5, 6, 7, 13, 19, 25, 31, 6*n+1, . . . ,].

In some example embodiments, the GNSS validity duration that UE reports may be the remaining validity duration. In some example embodiments, the UE may trigger the GNSS measurement reporting every time upon completing the GNSS fix operation.

In can be seen, the eNB may aperiodically trigger a GNSS measurement gap (MG) in which the UE can perform the measurement, and the trigger may be based on a downlink MAC CE and the network is free to decide when to trigger the GNSS measurement.

As discussed above, the 3GPP assumes the UE cannot operate GNSS and IoT NTN simultaneously and therefore RAN1 and RAN2 specify GNSS measurement gaps, where the UE can perform the GNSS measurement without monitoring the physical downlink control channel (PDCCH) and performing other “3GPP tasks”.

Generally speaking, the UE should not monitor the PDCCH, when it is performing the GNSS measurement, because the 3GPP receiver is not available, while the GNSS receiver is active. Further, when the UE has completed the GNSS measurement the 3GPP receiver is potentially available. However, the network may not know that the UE has finished the GNSS measurement and thus the network should not schedule the UE using PDCCH until the network is sure the UE can monitor the PDCCH.

In view of this, if the UE may provide early feedback on the completed GNSS measurement, e.g., transmission of SR or other indications related to reporting the new remaining GNSS validity duration, the network may understand that the GNSS has been completed. If so, the network may start PDCCH scheduling correspondingly early.

In case that the UE has completed GNSS measurement before the end of the GNSS measurement gap and the UE may report the new remaining GNSS validity duration after a successful GNSS measurement, another question is that how to ensure to the network and UE may have a common understanding about whether and how to perform PDCCH transmission (for the network) and whether and how to perform PDCCH monitoring/reception (for the UE).

According to some example embodiments of the present disclosure, there is provided a solution for monitoring for control information in a position measurement gap. In this solution, in accordance with a determination that a positioning measurement is completed in a positioning measurement gap, a first apparatus (such as, a terminal device) determines a first time point for a transmission of first information indicating the completion of the positioning measurement; and then determines whether to start monitoring for control information from a second apparatus (such as, a network device) before an end of the positioning measurement gap based on at least one of the following: the first time point, a round-trip time (RTT) between the first apparatus and the second apparatus, a processing time required by the second apparatus for processing the first information, or an offset associated with monitoring the control information. The second apparatus also may determine whether to start transmitting control information accordingly. As a result, the control information transmission may be performed within a positioning measurement gap, and thus the control information may be transmitted to the first apparatus timely.

As used herein, the terms “gap”, “duration”, “period”, “cycle”, “time length”, “window” may be used interchangeably.

In the following, a satellite will be used as an example of a network device for describing some specific example embodiments of the present disclosure. It is noted that example embodiments described with regard to the satellite are equally applicable to other type network device. The present disclosure is not limited in this regard.

Further, GNSS measurement may be used as an example of positioning measurement for describing some specific example embodiments of the present disclosure. It is noted that example embodiments described with regard to the satellite are equally applicable to other type positioning measurements, such as, 3GPP-based positioning measurement (e.g., multi-RTT or observed time difference of arrival, OTDOA). The present disclosure is not limited in this regard.

In some example embodiments, “UE-eNB RTT” may be used as an example of RTT between the first apparatus and the second apparatus. Specifically, for non-terrestrial networks, UE-eNB RTT may refer to the sum of the UE's Timing Advance value and k-Mac in units of subframe, not rounded or truncated toward an integer number of subframes. It is to be understand that when the solution is applied to other scenario rather than NTN, the definition of RTT may be re-defined accordingly.

It is noted that the PDCCH for NB-IoT is referred to as NPDCCH. The present disclosure may be equally applicable to this control channel.

Principles and implementations of the present disclosure will be described in detail below with reference to the figures.

It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### Example Environment

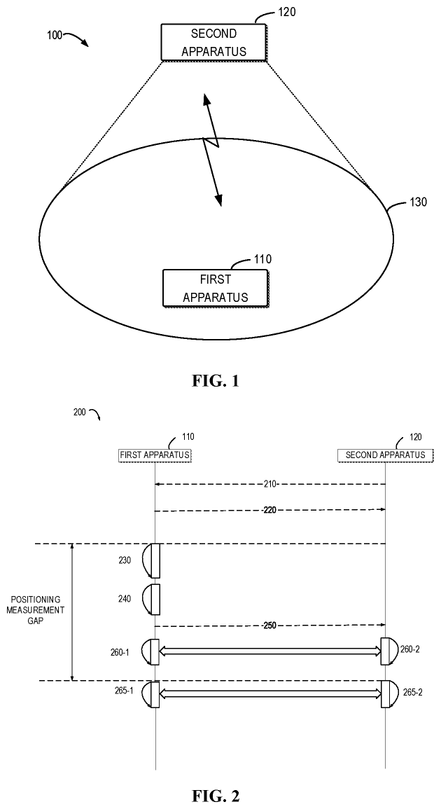

FIG. 1 illustrates an example communication environment 100 in which example embodiments of the present disclosure can be implemented. In the communication environment 100, a plurality of communication devices, including a first apparatus 110 and a second apparatus 120, can communicate with each other.

In the example of FIG. 1, the first apparatus 110 may include a terminal device and the second apparatus 120 may include a network device serving the terminal device. The serving area of the second apparatus 120 may be called a cell 130. It should be understood that the second apparatus 120 may be deployed within or out of the cell 130 according to different requirement scenarios.

In some example embodiments, the communication environment 100 is an NTN network including one or more satellites. In some example embodiments, an access network device (such as, a gNB) may be deployed at a satellite, also referred to as a regenerative architecture. Alternatively, in some example embodiments, an access network device may be deployed separately from the satellite, such as, deployed on the ground, also referred to as transparent architecture. In the present disclosure, according to the specific application scenario or requirements, either or both of the satellite and the access network device may be considered as the second apparatus 120. In present disclosure is not limited in this regard.

In the following, for the purpose of illustration, some example embodiments are described with the first apparatus 110 operating as a terminal device and the second device 120 operating as a network device. However, in some example embodiments, operations described in connection with a terminal device may be implemented at a network device or other device, and operations described in connection with a network device may be implemented at a terminal device or other device.

In some example embodiments, if the first apparatus 110 is a terminal device and the second apparatus 120 is a network device, a link from the second apparatus 120 to the first apparatus 110 is referred to as a downlink (DL), while a link from the first apparatus 110 to the second apparatus 120 is referred to as an uplink (UL). In DL, the second apparatus 120 is a transmitting (TX) device (or a transmitter) and the first apparatus 110 is a receiving (RX) device (or a receiver). In UL, the first apparatus 110 is a TX device (or a transmitter) and the second apparatus 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Work Principle and Example Signaling for Communication

In the following, more details about the operations upon a completion of positioning measurement (such as, GNSS) will be discussed with reference to FIG. 2 to FIG. 5. For the purposes of discussion, example signaling flows in FIG. 2 to FIG. 5 will be discussed with reference to FIG. 1, for example, by using the first apparatus 110 and the second apparatus 120.

In the example of FIG. 2 to FIG. 5, the first apparatus 110 may function as a terminal apparatus and the second apparatus 120 may function as a network apparatus.

It is to be understood that the operations at the first apparatus 110 and the second apparatus 120 should be coordinated. In other words, the second apparatus 120 and the first apparatus 110 should have common understanding about rules, configurations, parameters and so on. Such common understanding may be implemented by any suitable interactions or by applying the same rule/policy.

In the following, although some operations are described from a perspective of the first apparatus 110, it is to be understood that the corresponding operations should be performed by the second apparatus 120. Similarly, although some operations are described from a perspective of the second apparatus 120, it is to be understood that the corresponding operations should be performed by the first apparatus 110. Merely for brevity, some of the same or similar contents are omitted here.

In addition, in the following description, examples of message type (such as “RRC message”, “MAC CE”, “DCI”) are only for the purpose of illustration without suggesting any limitations. In other example embodiments, any suitable message types may be used for the interaction between the first apparatus 110 and the second apparatus 120.

In summary, the following example embodiments may well define when the UE shall monitor the PDCCH depending on the relationship between the time of transmitting the first information (related to the new remaining GNSS validity duration, and thus the first information also referred to as “information related to the new remaining GNSS validity duration” sometimes), the UE-eNB RTT, and the end of the network configured GNSS measurement gap.

In operations, the first apparatus 110 performs 230 a positioning measurement. Then, in accordance with a determination that the positioning measurement is completed in a positioning measurement gap, the first apparatus 110 determines 240 a first time point for a transmission of first information indicating the completion of the positioning measurement.

Next, the first apparatus 110 determines whether to start monitoring for control information from the second apparatus 120 before an end of the positioning measurement gap based on one or more factors.

In some example embodiments, the positioning measurement may be a 3GPP-based positioning measurement (such as, multi-RTT or OTDOA) or a global navigation satellite system (GNSS) measurement.

In some example embodiments, the control information may be carried on a physical downlink control channel (PDCCH).

Example factor of the one or more factors may be the following:
the first time point,
a round-trip time (RTT) between the first apparatus 110 and the second apparatus 120,
a processing time required by the second apparatus 120 for processing the first information, or
A an offset associated with monitoring the control information.

In some example embodiments, the offset refers to a time offset used for delaying the monitoring for the control information. Further, the reference point may be defined as any suitable time point, such as, the first time point and other time point. Additionally, in some example embodiments, the offset associated with monitoring the control information may be defined as a default value, configured by the second apparatus 120 or reported by the first apparatus 110.

In some example embodiments, the first apparatus 110 may transmit 250 the first information to the second apparatus 120. In this way, the second apparatus may obtain more exact time point about when the first apparatus 110 has completed the positioning measurement.

In the following, more details about the first information will be discussed. In some example embodiments, the first information may be one of the following:
a scheduling request (SR),
a buffer status report (BSR),
a physical random access channel (PRACH) transmission, or
a medium access control (MAC) control element (CE).

In some example embodiments, the first information may be transmitted on pre-configured resources.

In some example embodiments, before transmitting the first information, the first also may need to determine the first monitoring occasion of the control information. In some embodiments, the first monitoring occasion may be after the first time point if the first message is transmitted on pre-configured resources.

Alternatively, in some example embodiments, the first monitoring occasion may be after a second time point occurring after a duration from the first time point. Additionally, the duration may be determined based on at least one of the following: the RTT, the processing time, or the offset associated with monitoring the control information. In one example embodiment, the duration may be the RTT. In another example embodiment, the duration may be a sum of the RTT and the processing time. In a further example embodiment, the duration may be the offset associated with monitoring the control information.

In the following, how to determine whether to start monitoring for control information from the second apparatus 120 before an end of the positioning measurement gap based on the above one or more factors are discussed below.

In some example embodiments, the first apparatus 110 may start 260-1 monitoring for control information before the end of the positioning measurement gap in accordance with a determination that the end of the positioning measurement gap is after a second time point occurring after a duration from the first time point. As discussed above, the duration may be determined based on at least one of the following: the RTT, the processing time, or the offset associated with monitoring the control information.

Accordingly, the second apparatus 120 may start 260-2 transmitting control information before the end of the positioning measurement gap in accordance with a determination that the end of the positioning measurement gap is after a second time point occurring after a duration from receiving the first information.

In some example embodiments, the first apparatus 110 may start 265-1 monitoring for control information after the end of the positioning measurement gap in accordance with a determination that the end of the positioning measurement gap is before a second time point occurring after a duration from the first time point. As discussed above, the duration may be determined based on at least one of the following: the RTT, the processing time, or the offset associated with monitoring the control information.

Accordingly, the second apparatus 120 may start 265-2 start transmitting control information after the end of the positioning measurement gap in accordance with a determination that the end of the positioning measurement gap is before a second time point occurring after a duration from the first time point.

In case that the first apparatus is configured with a discontinuous reception (DRX) configuration, when to monitor for the control information may be determined further based on the DRX configuration.

In some example embodiments, if the first apparatus 110 is configured with a DRX configuration, the first apparatus 110 may apply the DRX configuration after the second time point. Applying the DRX configuration means to monitor the first DRX On Duration after the second time point.

Alternatively, in some example embodiments, if the first apparatus 110 is configured with a DRX configuration, the first apparatus 110 may enter DRX active time after the second time point without waiting for the first ON-duration configured by the DRX configuration.

In some example embodiments, the first apparatus 110 may receive 210 second information from the second apparatus 120, where the second information indicates at least one of the following:
a first indication used for enabling or disabling the transmission of the first information before the end of the positioning measurement gap,
a second indication used for enabling or disabling monitoring for the control information before the end of the positioning measurement gap, or
a third indication used for enabling or disabling monitoring for the control information after the end of the positioning measurement gap and before a second time point occurring after a duration from the first time point.

Additionally, all the above discussed procedures may be implemented as UE capability or configured by the second apparatus 120.

As illustrated in FIG. 2, in some example embodiments, the first apparatus 110 may transmit 220 third information to the second apparatus 120, where the third information indicates at least one of the following:
first capability-related information indicating whether the first apparatus 110 supports the transmission of the first information before the end of the positioning measurement gap,
second capability-related information indicating whether the first apparatus 110 supports monitoring for the control information before the end of the positioning measurement gap, or
third capability-related information indicating whether the first apparatus 110 supports monitoring for the control information after the end of the positioning measurement gap and a second time point occurring after a duration from the first time point.

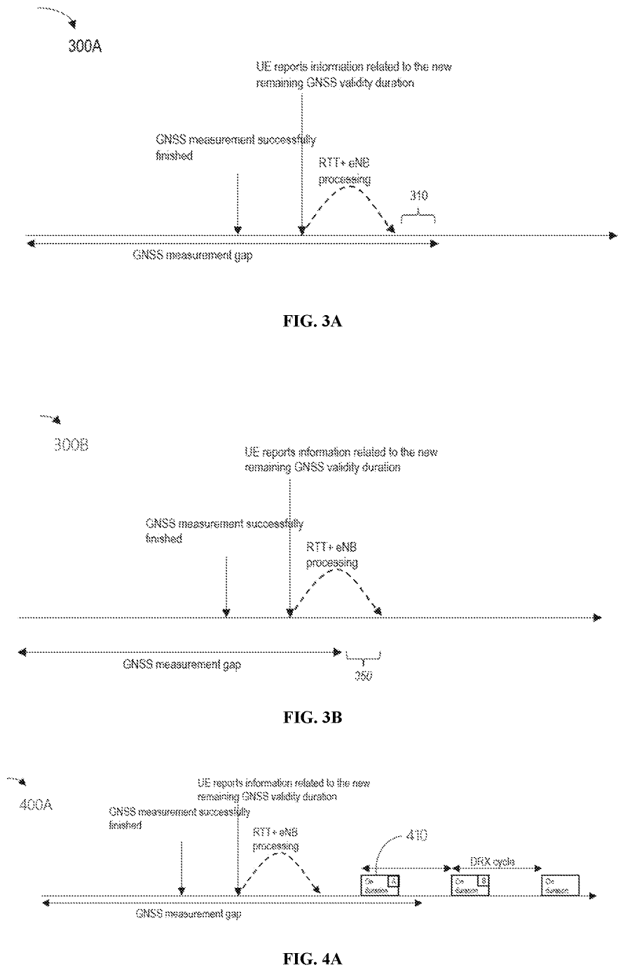

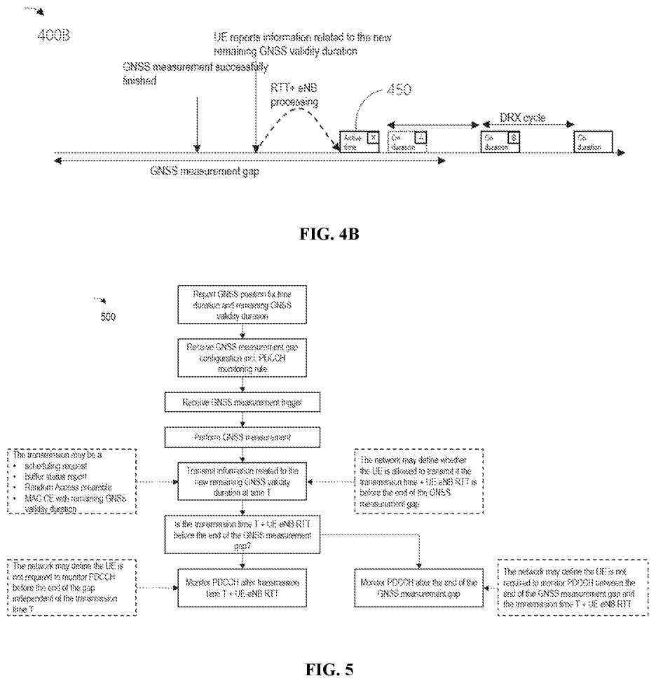

Merely for a better understanding of the above procedures, some example embodiments will be discussed with reference to FIG. 3A to FIG. 4B, which illustrate timings 300A, 300B, 400A and 400B for monitoring for control information in a positioning measurement gap.

In some example embodiments, if the report time of the “information related to the new remaining GNSS validity duration” and “UE-eNB RTT” is before the end of the scheduled GNSS measurement gap, the UE starts PDCCH monitoring before end of the measurement gap, i.e., during the time duration 310, the UE may start PDCCH monitoring, as illustrated in FIG. 3A.

In some example embodiments, the “information related to the new remaining GNSS validity duration” may be an SR, BSR, PRACH or MAC CE transmission of the new remaining GNSS validity duration in pre-configured resources.

In some example embodiments, the UE reports the “information related to the new remaining GNSS validity duration” in a pre-configured resource for SR/BSR or a PRACH resource. The UE may determine the first PDCCH monitoring occasion based on the time point of transmitting the report or PRACH (to synchronize with the network before the report has reached the network), where the time point of the pre-configured resource is known by network. The network may assume UE can report the new remaining GNSS validity duration on the pre-defined resource i.e., this report may not impact the PDCCH monitoring and e.g., scheduled DL data.

In some example embodiments, if the report time of the “information related to the new remaining GNSS validity duration” and “UE-eNB RTT” is after the end of the scheduled GNSS measurement gap, the UE may start PDCCH monitoring at the end of the measurement gap (i.e., before the eNB has received the information) As illustrated in FIG. 3B, the UE may monitor PDCCH during the time duration 350.

In one further embodiment, the network defines/configures:
A whether the UE is allowed to provide the information early, i.e., such that the report time+RTT have passed before the end of the GNSS measurement gap, i.e., the first indication;
A whether the UE is expected to monitor PDCCH before the end of the GNSS measurement gap, independent of whether the UE has reported early, i.e., the second indication;
whether the UE is expected to monitor PDCCH between the end of the GNSS measurement gap and the following report time+RTT in the scenario where the UE has reported (relatively) late, i.e., the third indication.

In some example embodiments, the PDCCH monitoring occasion may be based on the C-DRX if configured. In this case, the UE will monitor the PDCCH based on whether UE is in DRX Active time (for example, in the first C-DRX On Duration 410 as illustrated in FIG. 4A), which occurs after the UE has determined PDCCH monitoring shall resume before the end of the configured measurement gap. In FIG. 4A, UE monitors the On Duration #A (which is inside the GNSS measurement gap) instead of postponing the monitoring until after the GNSS measurement gap (On Duration #B).

In an alternative embodiment, the UE may trigger it enters C-DRX Active Time (such as, the active time 450 as illustrated in FIG. 4B) after the reporting time and “UE-eNB RTT” by triggering the start of either onDuration Timer or drx-Inactivity Timer, but this would only occur based on eNB configuration. In one example embodiment of FIG. 4B, the UE starts a new Active time #X right after the reporting time and “UE-eNB RTT”, instead of waiting for the On Duration A. Alternatively, in another example embodiment of FIG. 4B, the UE starts a new Active time #X right after the reporting time and still monitors the On Duration #A after the new Active time #X.

In some embodiment, the network may assume the UE has completed the measurement early and can therefore also monitor PDCCH early. This can reduce the latency, but will also waste resources and energy if the UE does not complete the measurement early. The UE may e.g., choose to monitor the PDCCH in a known window shortly after the pre-configured resource. If the UE does not receive anything in this window it can determine the network is not applying the opportunistic approach. Therefore, the UE shall fallback to monitor the PDCCH according to the other options i.e., after the report time and “UE-eNB RTT”.

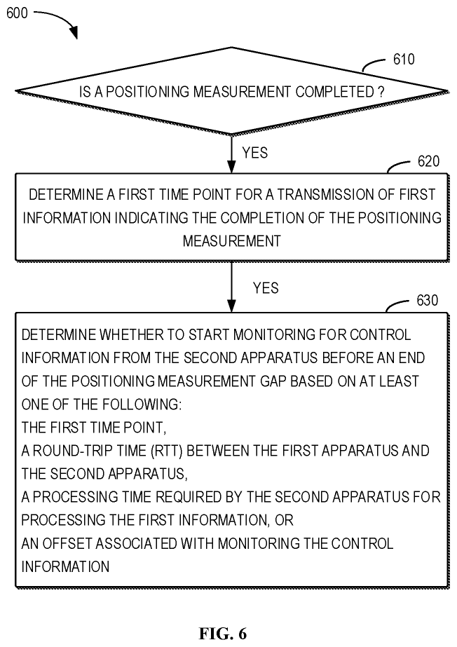

Reference is now made to FIG. 5, which illustrates a flowchart of a method 500 implemented at a first apparatus according to some example embodiments of the present disclosure.

In FIG. 5, the UE may report GNSS position fix time duration and remaining GNSS validity duration and may receive GNSS measurement gap configuration including PDCCH monitoring rule used for determining whether to start monitoring for control information before an end of the positioning measurement gap. Then, the UE may receive GNSS measurement trigger and performs GNSS measurement.

If needed, the UE may transmit information related to the new remaining GNSS validity duration at time T. The UE may determine the transmission time T and UE-eNB RTT (also may comprise a processing time required by the NW for processing the information related to the new remaining GNSS validity duration, an offset associated with monitoring for control information, and any other related factors) is before the end of the GNSS measurement gap. If so, the UE may monitor PDCCH after transmission time T and UE-eNB RTT, else, the UE may monitor PDCCH after the end of the GNSS measurement gap.

In summary, after the UE has reacquired the GNSS successfully, the UE may consider it is uplink synchronized. As a result, the UE may initiate uplink transmission to report the new remaining GNSS validity duration. However, until the UE has initiated such uplink transmission of the report the network is not aware that the UE has finished the measurement early/before the end of the GNSS measurement gap. Therefore, the UE is not required to monitor the PDCCH until the first uplink transmission and UE-eNB RTT if this occurs before the end of the GNSS measurement gap. According to the above example processes, the UE shall monitor the PDCCH after the first uplink transmission and UE-eNB RTT if this occurs before the GNSS measurement gap.

### Example Methods

FIG. 6 shows a flowchart of an example method 600 implemented at a first device in accordance with some example embodiments of the present disclosure. For the purpose of discussion, the method 600 will be described from the perspective of the first apparatus 110 in FIG. 1.

At block 610, the first apparatus determines whether a positioning measurement is completed in a positioning measurement gap.

At block 620, in accordance with a determination that a positioning measurement is completed in a positioning measurement gap, the first apparatus determines a first time point for a transmission of first information indicating the completion of the positioning measurement.

At block 630, the first apparatus determines whether to start monitoring for control information from a second apparatus before an end of the positioning measurement gap based on at least one of the following: the first time point, a round-trip time (RTT) between the first apparatus and the second apparatus, a processing time required by the second apparatus for processing the first information, or an offset associated with monitoring the control information.

In some example embodiments, the offset associated with monitoring the control information is defined as a default value, configured by the second apparatus or reported by the first apparatus.

In some example embodiments, the first apparatus may transmit the first information to the second apparatus.

In some example embodiments, the first information is one of the following: a scheduling request (SR), a buffer status report (BSR), a physical random access channel (PRACH) transmission, or a medium access control (MAC) control element (CE).

In some example embodiments, the first information is transmitted on pre-configured resources.

In some example embodiments, the first apparatus may start monitoring for control information before the end of the positioning measurement gap in accordance with a determination that the end of the positioning measurement gap is after a second time point occurring after a duration from the first time point, wherein the duration is determined based on at least one of the following: the RTT, the processing time, or the offset associated with monitoring the control information.

In some example embodiments, the first apparatus is configured with a discontinuous reception (DRX) configuration, the first apparatus may apply the DRX configuration after the second time point or enter DRX active time after the second time point without waiting for the first ON-duration configured by the DRX configuration.

In some example embodiments, the first apparatus may determine the first monitoring occasion of the control information, wherein the first monitoring occasion is after one of the following: a second time point occurring after the duration from the first time point, or the first time point if the first message is transmitted on pre-configured resources.

In some example embodiments, the first apparatus may start monitoring for control information after the end of the positioning measurement gap in accordance with a determination that the end of the positioning measurement gap is before a second time point occurring after a duration from the first time point, wherein the duration is determined based on at least one of the following: the RTT, the processing time, or the offset associated with monitoring the control information.

In some example embodiments, the first apparatus may receive, from the second apparatus, second information indicating at least one of the following: a first indication used for enabling or disabling the transmission of the first information before the end of the positioning measurement gap, a second indication used for enabling or disabling monitoring for the control information before the end of the positioning measurement gap, or a third indication used for enabling or disabling monitoring for the control information after the end of the positioning measurement gap and before a second time point occurring after a duration from the first time point.

In some example embodiments, the first apparatus may transmit, to the second apparatus, third information indicating at least one of the following: first capability-related information indicating whether the first apparatus supports the transmission of the first information before the end of the positioning measurement gap, second capability-related information indicating whether the first apparatus supports monitoring for the control information before the end of the positioning measurement gap, or third capability-related information indicating whether the first apparatus supports monitoring for the control information after the end of the positioning measurement gap and a second time point occurring after a duration from the first time point.

In some example embodiments, the positioning measurement is a third generation partnership project (3GPP)-based positioning measurement or a global navigation satellite system (GNSS) measurement, and the control information is carried on a physical downlink control channel (PDCCH).

In some example embodiments, the first apparatus is a terminal apparatus, the second apparatus is a network apparatus.

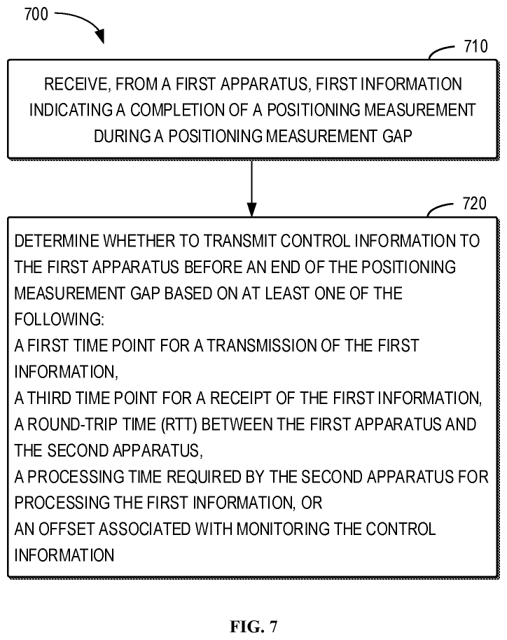

FIG. 7 shows a flowchart of an example method 700 implemented at a second device in accordance with some example embodiments of the present disclosure. For the purpose of discussion, the method 700 will be described from the perspective of the second apparatus 120 in FIG. 1.

At block 710, the second apparatus receives, from a first apparatus, first information indicating a completion of a positioning measurement during a positioning measurement gap.

At block 720, the second apparatus determines whether to transmit control information to the first apparatus before an end of the positioning measurement gap based on at least one of the following: a first time point for a transmission of the first information, a third time point for a receipt of the first information, a round-trip time (RTT) between the first apparatus and the second apparatus, a processing time required by the second apparatus for processing the first information, or an offset associated with monitoring the control information.

In some example embodiments, the offset associated with monitoring the control information is defined as a default value, configured by the second apparatus or reported by the first apparatus.

In some example embodiments, the first information is one of the following: a scheduling request (SR), a buffer status report (BSR), a physical random access channel (PRACH) transmission, or a medium access control (MAC) control element (CE).

In some example embodiments, the first information is transmitted on pre-configured resources.

In some example embodiments, the second apparatus may start transmitting control information before the end of the positioning measurement gap in accordance with a determination that the end of the positioning measurement gap is after a second time point occurring after a duration from receiving the first information, wherein the duration is determined based on at least one of the following: the RTT, the processing time, or the offset associated with monitoring the control information.

In some example embodiments, the second apparatus may determine the first transmission occasion of the control information, wherein the first transmission occasion is after one of the following: a second time point occurring after a duration from the first time point, or the first time point if the first message is transmitted on pre-configured resources.

In some example embodiments, the first apparatus is configured with a discontinuous reception (DRX) configuration, transmitting the control information during an ON-duration after the second time point, or transmitting the control information in DRX active time after the second time point without waiting for the first ON-duration configured by the DRX configuration.

In some example embodiments, the second apparatus may start transmitting control information after the end of the positioning measurement gap in accordance with a determination that the end of the positioning measurement gap is before a second time point occurring after a duration from the first time point, wherein the duration is determined based on at least one of the following: the RTT, the processing time, or the offset associated with monitoring the control information.

In some example embodiments, the second apparatus may transmit, to the first apparatus, second information indicating at least one of the following: a first indication used for enabling or disabling the transmission of the first information, a second indication used for enabling or disabling monitoring for the control information before the end of the positioning measurement gap, or a third indication used for enabling or disabling monitoring for the control information after the end of the positioning measurement gap and before a second time point occurring after a duration from the first time point.

In some example embodiments, the second apparatus may receive, from the first apparatus third information indicating at least one of the following: first capability-related information indicating whether the first apparatus supports the transmission of the first information before the end of the positioning measurement gap, second capability-related information indicating whether the first apparatus supports monitoring for the control information before the end of the positioning measurement gap, or third capability-related information indicating whether the first apparatus supports monitoring for the control information before the end of the positioning measurement gap and a second time point occurring after a duration from the transmission of the first information.

In some example embodiments, the positioning measurement is a third generation partnership project (3GPP)-based positioning measurement or a global navigation satellite system (GNSS) measurement, and the control information is carried on a physical downlink control channel (PDCCH).

In some example embodiments, the first apparatus is a terminal apparatus, the second apparatus is a network apparatus.

### Example Apparatus, Device and Medium

In some example embodiments, a first apparatus capable of performing any of the method 600 (for example, the first apparatus 110 in FIG. 1) may comprise means for performing the respective operations of the method 600. The means may be implemented in any suitable form. For example, the means may be implemented in a circuitry or software module. The first apparatus may be implemented as or included in the first apparatus 110 in FIG. 1.

In some example embodiments, the first apparatus comprises means for in accordance with a determination that a positioning measurement is completed in a positioning measurement gap, determining a first time point for a transmission of first information indicating the completion of the positioning measurement; and means for determining whether to start monitoring for control information from a second apparatus before an end of the positioning measurement gap based on at least one of the following: the first time point, a round-trip time (RTT) between the first apparatus and the second apparatus, a processing time required by the second apparatus for processing the first information, or an offset associated with monitoring the control information.

In some example embodiments, the offset associated with monitoring the control information is defined as a default value, configured by the second apparatus or reported by the first apparatus.

In some example embodiments, the first apparatus further comprises: means for transmitting the first information to the second apparatus.

In some example embodiments, the first information is one of the following: a scheduling request (SR), a buffer status report (BSR), a physical random access channel (PRACH) transmission, or a medium access control (MAC) control element (CE).

In some example embodiments, the first information is transmitted on pre-configured resources.

In some example embodiments, the first apparatus further comprises: means for starting monitoring for control information before the end of the positioning measurement gap in accordance with a determination that the end of the positioning measurement gap is after a second time point occurring after a duration from the first time point, wherein the duration is determined based on at least one of the following: the RTT, the processing time, or the offset associated with monitoring the control information.

In some example embodiments, the first apparatus is configured with a discontinuous reception (DRX) configuration, means for applying the DRX configuration after the second time point, or means for entering DRX active time after the second time point without waiting for the first ON-duration configured by the DRX configuration.

In some example embodiments, the first apparatus further comprises: means for determining the first monitoring occasion of the control information, wherein the first monitoring occasion is after one of the following: a second time point occurring after the duration from the first time point, or the first time point if the first message is transmitted on pre-configured resources.

In some example embodiments, the first apparatus further comprises: means for starting monitoring for control information after the end of the positioning measurement gap in accordance with a determination that the end of the positioning measurement gap is before a second time point occurring after a duration from the first time point, wherein the duration is determined based on at least one of the following: the RTT, the processing time, or the offset associated with monitoring the control information.

In some example embodiments, the first apparatus further comprises: means for receiving, from the second apparatus, second information indicating at least one of the following: a first indication used for enabling or disabling the transmission of the first information before the end of the positioning measurement gap, a second indication used for enabling or disabling monitoring for the control information before the end of the positioning measurement gap, or a third indication used for enabling or disabling monitoring for the control information after the end of the positioning measurement gap and before a second time point occurring after a duration from the first time point.

In some example embodiments, the first apparatus further comprises: means for transmitting, to the second apparatus, third information indicating at least one of the following: first capability-related information indicating whether the first apparatus supports the transmission of the first information before the end of the positioning measurement gap, second capability-related information indicating whether the first apparatus supports monitoring for the control information before the end of the positioning measurement gap, or third capability-related information indicating whether the first apparatus supports monitoring for the control information after the end of the positioning measurement gap and a second time point occurring after a duration from the first time point.

In some example embodiments, the positioning measurement is a third generation partnership project (3GPP)-based positioning measurement or a global navigation satellite system (GNSS) measurement, and the control information is carried on a physical downlink control channel (PDCCH).

In some example embodiments, the first apparatus is a terminal apparatus, the second apparatus is a network apparatus.

In some example embodiments, the first apparatus further comprises means for performing other operations in some example embodiments of the method 600 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 700 (for example, the second apparatus 120 in FIG. 1) may comprise means for performing the respective operations of the method 700. The means may be implemented in any suitable form. For example, the means may be implemented in a circuitry or software module. The second apparatus may be implemented as or included in the second apparatus 120 in FIG. 1.

In some example embodiments, the second apparatus comprises means for receiving, from a first apparatus, first information indicating a completion of a positioning measurement during a positioning measurement gap; and means for determining whether to transmit control information to the first apparatus before an end of the positioning measurement gap based on at least one of the following: a first time point for a transmission of the first information, a third time point for a receipt of the first information, a round-trip time (RTT) between the first apparatus and the second apparatus, a processing time required by the second apparatus for processing the first information, or an offset associated with monitoring the control information.

In some example embodiments, the offset associated with monitoring the control information is defined as a default value, configured by the second apparatus or reported by the first apparatus.

In some example embodiments, the first information is one of the following: a scheduling request (SR), a buffer status report (BSR), a physical random access channel (PRACH) transmission, or a medium access control (MAC) control element (CE).

In some example embodiments, the first information is transmitted on pre-configured resources.

In some example embodiments, the second apparatus further comprises: means for starting transmitting control information before the end of the positioning measurement gap in accordance with a determination that the end of the positioning measurement gap is after a second time point occurring after a duration from receiving the first information, wherein the duration is determined based on at least one of the following: the RTT, the processing time, or the offset associated with monitoring the control information.

In some example embodiments, the second apparatus further comprises: means for determining the first transmission occasion of the control information, wherein the first transmission occasion is after one of the following: a second time point occurring after a duration from the first time point, or the first time point if the first message is transmitted on pre-configured resources.

In some example embodiments, the first apparatus is configured with a discontinuous reception (DRX) configuration, means for transmitting the control information during an ON-duration after the second time point, or means for transmitting the control information in DRX active time after the second time point without waiting for the first ON-duration configured by the DRX configuration.

In some example embodiments, the second apparatus further comprises: means for starting transmitting control information after the end of the positioning measurement gap in accordance with a determination that the end of the positioning measurement gap is before a second time point occurring after a duration from the first time point, wherein the duration is determined based on at least one of the following: the RTT, the processing time, or the offset associated with monitoring the control information.

In some example embodiments, the second apparatus further comprises: means for transmitting, to the first apparatus, second information indicating at least one of the following: a first indication used for enabling or disabling the transmission of the first information, a second indication used for enabling or disabling monitoring for the control information before the end of the positioning measurement gap, or a third indication used for enabling or disabling monitoring for the control information after the end of the positioning measurement gap and before a second time point occurring after a duration from the first time point.

In some example embodiments, the second apparatus further comprises: means for receiving, from the first apparatus third information indicating at least one of the following: first capability-related information indicating whether the first apparatus supports the transmission of the first information before the end of the positioning measurement gap, second capability-related information indicating whether the first apparatus supports monitoring for the control information before the end of the positioning measurement gap, or third capability-related information indicating whether the first apparatus supports monitoring for the control information before the end of the positioning measurement gap and a second time point occurring after a duration from the transmission of the first information.

In some example embodiments, the positioning measurement is a third generation partnership project (3GPP)-based positioning measurement or a global navigation satellite system (GNSS) measurement, and the control information is carried on a physical downlink control channel (PDCCH).

In some example embodiments, the first apparatus is a terminal apparatus, the second apparatus is a network apparatus.

In some example embodiments, the second apparatus further comprises means for performing other operations in some example embodiments of the method 700 or the second apparatus 120. In some example embodiments, the means comprises at least one processor; and at least one memory storing instructions that, when executed by the at least one processor, cause the performance of the second apparatus.

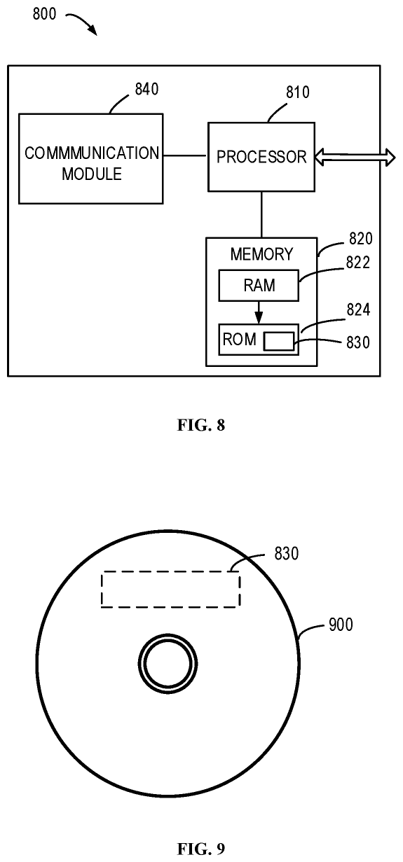

FIG. 8 is a simplified block diagram of a device 800 that is suitable for implementing example embodiments of the present disclosure. The device 800 may be provided to implement a communication device, for example, the first device 110 or the second apparatus 120 as shown in FIG. 1. As shown, the device 800 includes one or more processors 810, one or more memories 820 coupled to the processor 810, and one or more communication modules 840 coupled to the processor 810.

The communication module 840 is for bidirectional communications. The communication module 840 has one or more communication interfaces to facilitate communication with one or more other modules or devices. The communication interfaces may represent any interface that is necessary for communication with other network elements. In some example embodiments, the communication module 840 may include at least one antenna.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The instructions of the program 830 may include instructions for performing operations/acts of some example embodiments of the present disclosure. The program 830 may be stored in the memory, e.g., the ROM 824. The processor 810 may perform any suitable actions and processing by loading the program 830 into the RAM 822.

The example embodiments of the present disclosure may be implemented by means of the program 830 so that the device 800 may perform any process of the disclosure as discussed with reference to FIG. 2 to FIG. 7. The example embodiments of the present disclosure may also be implemented by hardware or by a combination of software and hardware.

In some example embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 9 shows an example of the computer readable medium 900 which may be in form of CD, DVD or other optical storage disk. The computer readable medium 900 has the program 830 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-28. (canceled)

29. A terminal apparatus for wireless communication, comprising:
at least one processor; and
at least one memory storing instructions that, when executed by the at least one processor, cause the terminal apparatus to:
in accordance with a determination that a global navigation satellite system (GNSS) positioning measurement of the terminal apparatus is completed in a positioning measurement gap, determine a first time point for a transmission to a non-terrestrial network (NTN) apparatus, of first information indicating the completion of the global navigation satellite system positioning measurement; and
determine whether to start monitoring for control information from the non-terrestrial network apparatus before an end of the global navigation satellite system positioning measurement gap based on at least one of the following:
the first time point,
a round-trip time (RTT) between the terminal apparatus and the non-terrestrial network apparatus,
a processing time required by the non-terrestrial network apparatus for processing the first information, or
an offset associated with monitoring the control information.

30. The terminal apparatus of claim 29, wherein the offset associated with monitoring the control information is defined as a default value, configured by the non-terrestrial network apparatus or reported by the terminal apparatus.

31. The terminal apparatus of claim 29, wherein the terminal apparatus is further caused to:
transmit the first information to the non-terrestrial network apparatus.

32. The terminal apparatus of claim 29, wherein the first information is one of the following:
a scheduling request (SR),
a buffer status report (BSR),
a physical random access channel (PRACH) transmission, or
a medium access control (MAC) control element (CE).

33. The terminal apparatus of claim 29, wherein the first information is transmitted on pre-configured resources, and wherein the control information is carried on a physical downlink control channel (PDCCH).

34. The terminal apparatus of claim 29, wherein the terminal apparatus is further caused to:
start monitoring for control information before the end of the positioning measurement gap in accordance with a determination that the end of the positioning measurement gap is after a second time point occurring after a duration from the first time point,
wherein the duration is determined based on at least one of the following: the RTT, the processing time, or the offset associated with monitoring the control information.

35. The terminal apparatus of claim 34, wherein the terminal apparatus is configured with a discontinuous reception (DRX) configuration,
and wherein the terminal apparatus is further caused to:
apply the DRX configuration after the second time point, or
enter DRX active time after the second time point without waiting for the first ON-duration configured by the DRX configuration.

36. The terminal apparatus of claim 29, wherein the terminal apparatus is further caused to:
determine the first monitoring occasion of the control information, wherein the first monitoring occasion is after one of the following:
a second time point occurring after the duration from the first time point, or
the first time point if the first message is transmitted on pre-configured resources.

37. The terminal apparatus of claim 29, wherein the terminal apparatus is further caused to:
start monitoring for control information after the end of the positioning measurement gap in accordance with a determination that the end of the positioning measurement gap is before a second time point occurring after a duration from the first time point,
wherein the duration is determined based on at least one of the following: the RTT, the processing time, or the offset associated with monitoring the control information.

38. The terminal apparatus of claim 29, wherein the terminal apparatus is further caused to:
receive, from the non-terrestrial network apparatus, second information indicating at least one of the following:
a first indication used for enabling or disabling the transmission of the first information before the end of the positioning measurement gap,
a second indication used for enabling or disabling monitoring for the control information before the end of the positioning measurement gap, or
a third indication used for enabling or disabling monitoring for the control information after the end of the positioning measurement gap and before a second time point occurring after a duration from the first time point.

39. The terminal apparatus of claim 29, wherein the terminal apparatus is further caused to:
transmit, to the non-terrestrial network second apparatus, third information indicating at least one of the following:
first capability-related information indicating whether the terminal apparatus supports the transmission of the first information before the end of the positioning measurement gap,
second capability-related information indicating whether the terminal apparatus supports monitoring for the control information before the end of the positioning measurement gap, or
third capability-related information indicating whether the terminal apparatus supports monitoring for the control information after the end of the positioning measurement gap and a second time point occurring after a duration from the first time point.

40. A non-terrestrial network apparatus for wireless communication, comprising:
at least one processor; and
at least one memory storing instructions that, when executed by the at least one processor, cause the non-terrestrial network apparatus to:
receive, from a terminal apparatus, first information indicating a completion of a global navigation satellite system (GNSS) positioning measurement during a positioning measurement gap; and
determine whether to transmit control information to the terminal apparatus before an end of the positioning measurement gap based on at least one of the following:
a first time point for a transmission of the first information,
a third time point for a receipt of the first information,
a round-trip time (RTT) between the terminal apparatus and the non-terrestrial network apparatus,
a processing time required by the second apparatus for processing the first information, or
an offset associated with monitoring the control information.

41. The non-terrestrial network apparatus of claim 40, wherein the offset associated with monitoring the control information is defined as a default value, configured by the non-terrestrial network apparatus or reported by the terminal apparatus.

42. The non-terrestrial network apparatus of claim 40, wherein the first information is one of the following:
a scheduling request (SR),
a buffer status report (BSR),
a physical random access channel (PRACH) transmission, or
a medium access control (MAC) control element (CE).

43. The non-terrestrial network apparatus of claim 40, wherein the non-terrestrial network apparatus is further caused to:
start transmitting control information before the end of the positioning measurement gap in accordance with a determination that the end of the positioning measurement gap is after a second time point occurring after a duration from receiving the first information,
wherein the duration is determined based on at least one of the following: the RTT, the processing time, or the offset associated with monitoring the control information.

44. The non-terrestrial network apparatus of any of claim 40, wherein the non-terrestrial network apparatus is further caused to:
determine the first transmission occasion of the control information, wherein the first transmission occasion is after one of the following:
a second time point occurring after a duration from the first time point, or
the first time point if the first message is transmitted on pre-configured resources.

45. The non-terrestrial network apparatus of claim 40, wherein the terminal apparatus is configured with a discontinuous reception (DRX) configuration,
and wherein the non-terrestrial network apparatus is further caused to:
transmit the control information during an ON-duration after the second time point, or
transmit the control information in DRX active time after the second time point without waiting for the first ON-duration configured by the DRX configuration.

46. The non-terrestrial network apparatus of claim 40, wherein the terminal apparatus is further caused to:
start transmitting control information after the end of the positioning measurement gap in accordance with a determination that the end of the positioning measurement gap is before a second time point occurring after a duration from the first time point,
wherein the duration is determined based on at least one of the following: the RTT, the processing time, or the offset associated with monitoring the control information.

47. The non-terrestrial network apparatus of claim 40, wherein the terminal apparatus is further caused to:
transmit, to the terminal apparatus, second information indicating at least one of the following:
a first indication used for enabling or disabling the transmission of the first information,
a second indication used for enabling or disabling monitoring for the control information before the end of the positioning measurement gap, or
a third indication used for enabling or disabling monitoring for the control information after the end of the positioning measurement gap and before a second time point occurring after a duration from the first time point.

48. The non-terrestrial network apparatus of claim 40, wherein the terminal apparatus is further caused to:
receive, from the terminal apparatus third information indicating at least one of the following:
first capability-related information indicating whether the terminal apparatus supports the transmission of the first information before the end of the positioning measurement gap,
second capability-related information indicating whether the terminal apparatus supports monitoring for the control information before the end of the positioning measurement gap, or
third capability-related information indicating whether the terminal apparatus supports monitoring for the control information before the end of the positioning measurement gap and a second time point occurring after a duration from the transmission of the first information.
